(19) United States
(12) Patent Application Publication
(10) Pub. No.: US 2026/0289506 A1
(43) Pub. Date: Sep. 24, 2026

(54) State-Aware Orchestration System for Dynamic Coordination of Routing, Scheduling, and Transactional Resources in Event Environments

(71) Applicant: Daniel Round, Hankinson, ND (US)

(72) Inventor: Daniel Round, Hankinson, ND (US)

(21) Appl. No.: 19/571,203

(22) Filed: Mar. 18, 2026

Related U.S. Application Data
(60) Provisional application No. 63/775,908, filed on Mar. 21, 2025.

(51) Int. Cl. G06Q 10/10

(52) U.S. Cl. CPC G06Q 10/103

(57) ABSTRACT

A system for assisting experience of an event includes a structured event state model; a structured attendee state model; a multi-agent computational architecture in communication with the structured event state model and the structured attendee state model to continuously update the structured event state model and the structured attendee state model; an orchestration engine in communication with the multi-agent computational architecture that utilizes a constraint hierarchy governing decisions; and a conversational interface in communication with the orchestration engine to return structured outputs for each attendee in the structured attendee state model through the conversational interface in response to real-time disruptions in the structured attendee state model and the structured attendee state model.

### CROSS REFERENCE TO RELATED APPLICATION[S]

The present disclosure claims priority to U.S. Provisional Patent Disclosure Ser. No. 63/775,908, filed Mar. 21, 2025.

### BACKGROUND

The present disclosure relates to a state-aware, multi-agent orchestration engine that dynamically coordinates spatial routing, temporal scheduling, and transactional resource allocation within an event environment through a conversational interface using continuously updated environmental, operational, and attendee-specific state data.

Music festivals and large-scale entertainment events are expansive and often overwhelming to attendees due to the sheer number of stages, performers, vendors, and attractions. With hundreds of DJs, multiple performance areas, and large venues that require extensive navigation, attendees can become lost, miss key performances, or struggle to maximize their experience. Additionally, vendors and attractions within these events frequently suffer from low visibility and poor sales due to ineffective marketing and difficulty in guiding customers to their locations.

This background section is intended to introduce the reader to various aspects of art that may be related to various aspects of the present disclosure, which are described and/or claimed below. This discussion is believed to assist the reader with background information to facilitate a better understanding of the various aspects of the present disclosure. Accordingly, it should be understood that these statements are to be read in this light, and not as admissions of prior art.

### SUMMARY

A system for assisting experience of an event according to one disclosed non-limiting embodiment of the present disclosure includes a structured event state model; a structured attendee state model; a multi-agent computational architecture in communication with the structured event state model and the structured attendee state model to continuously update the structured event state model and the structured attendee state model; an orchestration engine in communication with the multi-agent computational architecture that utilizes a constraint hierarchy governing decisions; and a conversational interface in communication with the orchestration engine to return structured outputs for each attendee in the structured attendee state model through the conversational interface in response to real-time disruptions in the structured attendee state model and the structured attendee state model.

A further embodiment of any of the foregoing embodiments of the present disclosure includes, wherein the structured outputs for each attendee in the structured attendee state model comprises at least one of a schedule, a computed navigation path, an optimized itinerary, a reservation written into integrated systems, a VIP/table assignments, a ride timing adjustments, a personalized offer, and structured confirmation in response to the orchestration engine.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic view of a system for assisting experience of an event according to one disclosed non-limiting embodiment.

FIG. 2 is a screenshot of a user interface with the system according to one disclosed non-limiting embodiment.

FIG. 3 is a screenshot of a user interface with the system according to one disclosed non-limiting embodiment.

FIG. 4 is a block diagram illustrating a method of operation of the system according to one disclosed non-limiting embodiment.

### DETAILED DESCRIPTION

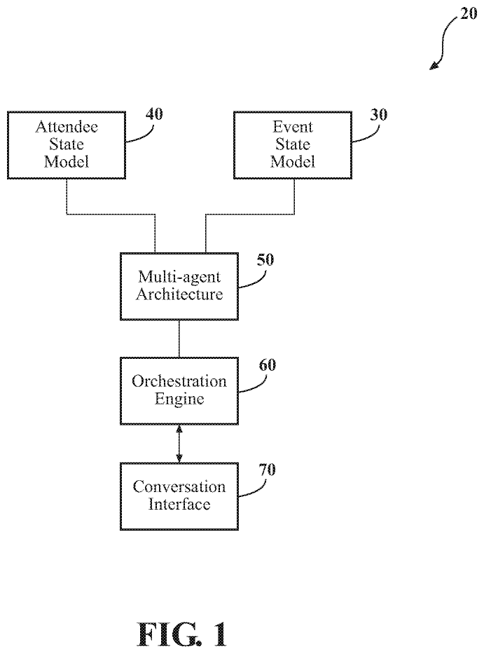

FIG. 1 schematically illustrates a system 20 for assisting experience of an event such as a multistage concert, fair, etc. The system 20 generally includes a structured event state model 30, a structured attendee state model 40, a multi-agent computational architecture 50, an orchestration engine 60, and a conversational interface 70. Large-scale event environments such as festivals, theme parks, exhibitions, trade shows, multi-venue entertainment districts, and sporting venues present coordination challenges due to distributed attractions, limited-capacity resources, dynamic scheduling changes, and high attendee density. Existing systems typically provide static maps, isolated scheduling tools, or standalone purchasing interfaces but do not integrate spatial routing, scheduling, operational data, and transactional resource allocation into a unified system capable of responding dynamically to changing conditions.

In some embodiments, the event environment may include a virtual event environment or a hybrid event environment that combines both physical and digital venues. In such embodiments, spatial routing may correspond to navigation within a digital venue interface, virtual environment, or event platform, and attendee location data may correspond to a user's presence within a virtual session, digital stage, or online interaction space. The orchestration engine may coordinate scheduling, routing, and transactional resource allocation for both in-person attendees and remote participants.

The structured event state model 30 includes venue geometry, schedules, operational constraints, inventory, safety parameters, etc. The structured event state model 30 may pull structured data from across the entire event ecosystem, including ERP systems, ticketing platforms, POS systems, workforce management systems, ride/attraction control systems, hospitality/VIP table management tools, CAD drawings, GIS mapping layers, scheduling systems, safety monitoring systems, and other operational work center data.

The structured event state model 30 may normalize the data into a machine-readable event state model. The multi-agent computational architecture 50 then continuously updates the structured event state model 30 with live environmental, behavioral, and operational signals.

The structured attendee state model 40 maintains a persistent attendee profile model such as, preferences, behavior signals, contextual tendencies. This may include explicit preferences (artists, food types, VIP interests, accessibility needs), implicit behavioral signals (movement patterns, dwell time, purchases, interaction history), contextual tendencies (time-of-day behaviors, congestion avoidance patterns), and cross-event learning where permitted.

For each attendee, the structured attendee state model 40 may also include a user device location, crowd density from sensors or camera analytics, ride telemetry and queue length, weather feeds, live schedule changes, flash promotions, vendor stock updates, safety alerts, staffing changes, and group member movement. These are ingested via APIs, sensor feeds, or event-driven triggers and applied to both the event state and attendee state models.

The structured event state model 30 and the structured attendee state model 40 may leverage external tools by programmatically issuing a series of API calls to web services and other re-sources, enabling them to accomplish more complex tasks, such as autonomously browsing the web, workforce API, weather API, etc.

The multi-agent computational architecture 50 may provide a framework where multiple independent agents—each capable of autonomous decision-making—work together to achieve complex goals via communication with the structured event state model 30 and the structured attendee state model 40. These agents can collaborate, coordinate, or even compete, depending on the system's objectives, may build and update a structured user state representation and use that model to influence ranking, routing, prioritization, and action recommendations in real time.

The multi-agent computational architecture 50 may maintain a shared understanding of the environment's state—such as real-time attendance, venue capacity, and participant locations—to optimize workflows, handle failures, and ensure “durable execution” of tasks, often leveraging technologies like temporal orchestration and blockchain for secure, real-time coordination. Independent agents may be assigned specific roles (e.g., spatial routing, temporal scheduling) and interact with each other to solve complex problems. A supervisory or “arbiter” agent may manage high-level orchestration, ensuring that individual agent actions align with global goals.

In one embodiment, each agent within the multi-agent computational architecture generates candidate actions based on its domain responsibility. For example, a spatial routing agent may recommend directing an attendee to a particular performance stage based on attendee preference data and current schedule availability. At the same time, a capacity monitoring agent may detect that the same stage has reached an occupancy threshold.

The orchestration engine resolves this conflict using a predefined constraint hierarchy. In one example hierarchy, safety constraints and capacity constraints take precedence over personalization preferences. Accordingly, if the capacity monitoring agent indicates that the venue has reached an occupancy threshold, the orchestration engine overrides the routing agent's proposal and instead selects an alternative location that satisfies the higher-priority constraints.

This arbitration mechanism ensures that agent outputs remain consistent with global system rules and operational constraints.

The orchestration engine 60 is in communication with the multi-agent computational architecture. The orchestration engine 60 provides a software platform that automates, coordinates, and manages complex, multi-step workflows across systems, applications, and human tasks in real-time. The orchestration engine may use triggers and rules to execute, monitor, and optimize processes, ensuring efficiency and scalability. Examples include AI-driven agent orchestrators, business process automation tools, and DevOps infrastructure managers.

The orchestration engine 60 creates, manages, and updates schedules dynamically (e.g., adjusting session times based on speaker arrival) for each attendee in the structured attendee state model. Resources may be allocated through a “transactional” approach, meaning allocations are atomic and guaranteed to be consistent, preventing conflicts like double-booking, etc.

In one embodiment, transactional allocation is performed when the system assigns a limited-capacity resource through a confirmed transaction.

For example, an attendee may request to purchase food from a vendor using the conversational interface. The request is transmitted to the orchestration engine, which queries the vendor system through an integrated API to determine inventory availability. If the requested item is available, the orchestration engine temporarily locks the corresponding inventory item to prevent simultaneous allocation to another user.

Once availability is confirmed, the orchestration engine records the transaction, updates the vendor inventory counter, and generates a confirmation object associated with the attendee's state model. The confirmation object is transmitted to the attendee's device and may include order confirmation information and pickup instructions.

This atomic transaction process ensures that vendor inventory remains consistent and prevents oversubscription of limited resources.

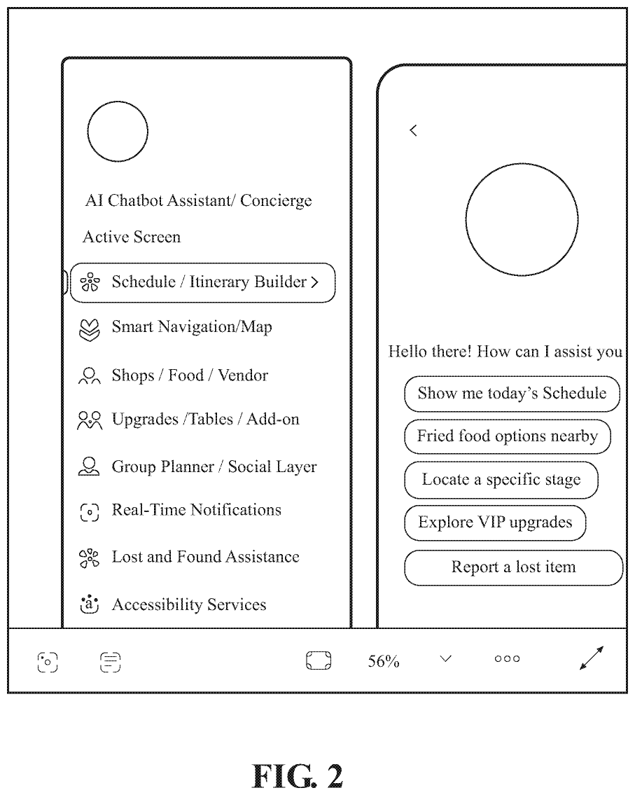

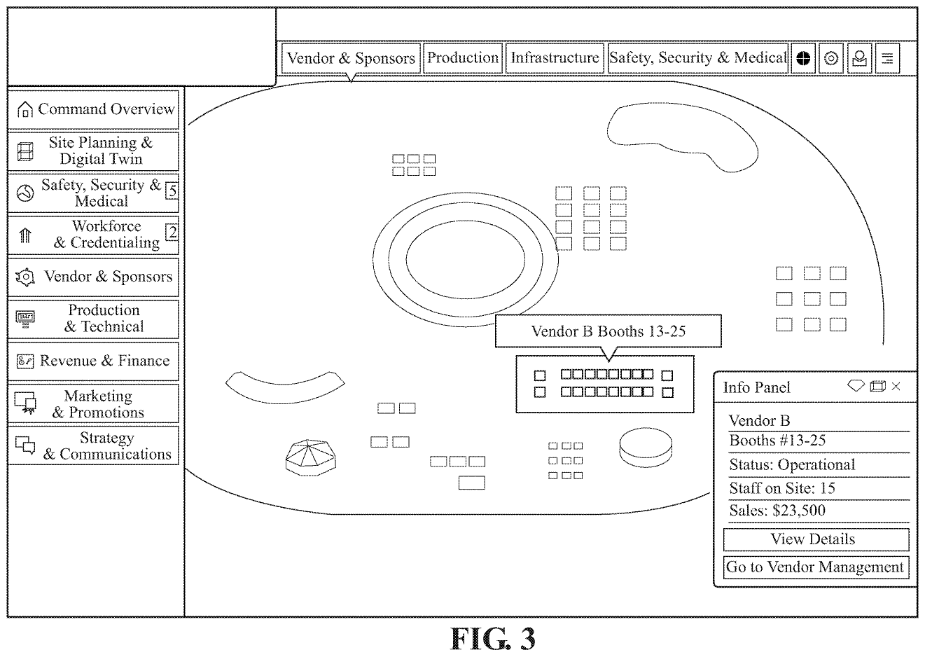

The conversational interface 70 may be accessed via a user-facing interface (FIG. 2) such as on a mobile device and is in communication with the orchestration engine 60 to return structured outputs (FIG. 3) for each attendee in the structured attendee state model through the conversational interface 70 in response to real-time disruptions in the structured attendee state model 40 and the event state model 30. In embodiments, the structured outputs for each attendee in the structured attendee state model comprises at least one of a schedule, a computed navigation path, an optimized itinerary, a reservation written into integrated systems, a VIP/table assignments, a ride timing adjustments, a personalized offer, and structured confirmation in response to the orchestration engine.

The conversational interface operates as an interaction layer between the attendee device and the orchestration engine. User inputs received through the conversational interface are processed to identify structured intent objects corresponding to system actions such as navigation requests, scheduling inquiries, or resource reservations.

The orchestration engine evaluates the intent object and invokes one or more agents within the multi-agent computational architecture to generate candidate actions. These candidate actions are evaluated using a constraint hierarchy and scoring mechanism before a final action is selected.

The system may also include an adaptive learning component that updates attendee preference vectors based on historical interaction data. For example, the system may analyze accepted recommendations, dwell time at particular locations, purchasing behavior, and congestion avoidance patterns. These behavioral signals are incorporated into the attendee state model and influence future recommendation scoring.

When a trigger event occurs, the orchestration engine re-evaluates routing, scheduling, or allocation decisions using updated state data and transmits revised structured outputs to the attendee device. Trigger events represent operational or environmental changes that may affect routing, scheduling, or resource allocation decisions.

Examples of trigger events may include:
User device location displacement exceeding a defined distance threshold
Queue length exceeding a predefined capacity threshold
Ride or attraction downtime reported through telemetry systems
Schedule modifications received from event control systems
Weather alerts received from external data feeds
Vendor inventory updates or promotional events
Safety alerts or crowd density changes detected through monitoring systems

Trigger events may be detected through mechanisms such as API polling, webhook notifications, sensor data ingestion, or event-driven messaging systems.

Upon detection of a trigger event, the orchestration engine evaluates whether existing routing, scheduling, or allocation decisions should be re-optimized.

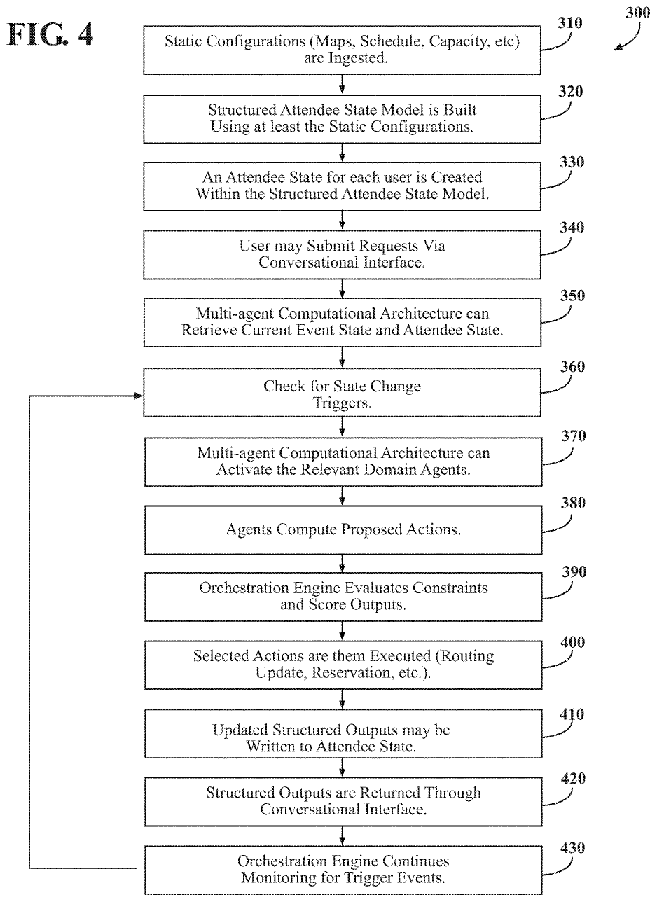

With reference to FIG. 4 a method 300 illustrating operation of the system 20 is schematically illustrated. The functions may be programmed software routines capable of execution in various microprocessor-based electronics control embodiments and are represented herein as block diagrams.

Initially, static configurations (maps, schedule, capacity, etc.) are ingested (310).

Next, the structured attendee state model is built using at least the static configurations (320).

Next, an attendee state object for each user is created within the structured attendee state model (330).

Once created, and the user logs in, the user may submit requests via conversational interface (340).

In response to, for example, the user submitted requests through the conversational interface 70, the multi-agent computational architecture can retrieve current event state and attendee state (350) then check for state change triggers (360). Trigger events may include operational or environmental changes such as user location displacement beyond a threshold distance, ride downtime notifications, queue length exceeding a capacity threshold, schedule updates, weather alerts, or vendor inventory changes. Detection of a trigger event causes the orchestration engine to re-evaluate routing, scheduling, or resource allocation decisions.

In some embodiments, transactional allocation occurs when a user purchases or reserves a limited-capacity resource such as food from a vendor, a ride reservation, or a VIP hospitality table. The orchestration engine verifies availability through an integrated vendor or operations system, temporarily locks the requested resource, confirms availability, records the transaction, updates capacity counters, and returns a confirmation object to the user device.

In response to state change triggers, the multi-agent computational architecture can activate the relevant domain agents (370) such that the agents compute proposed actions (380).

In some embodiments, domain-specific agents generate candidate actions based on their respective domains (e.g., routing, scheduling, capacity management). These candidate actions are submitted to the orchestration engine, which resolves potential conflicts using a predefined constraint hierarchy.

Next, the orchestration engine evaluates constraints and scores outputs (390).

Selected actions are then executed (routing update, reservation, etc.) (400).

In one embodiment, the orchestration engine collects proposed actions generated by multiple agents and evaluates those actions using a multi-stage decision process.

First, proposed actions that violate hard constraints, such as safety limits, capacity restrictions, or access permissions, are removed from consideration. Next, the remaining candidate actions are evaluated using a weighted scoring function that considers factors such as attendee preference alignment, temporal feasibility, resource availability, and congestion impact.

The orchestration engine selects the highest-scoring feasible action and commits the selected action for execution. The resulting structured output is recorded within the attendee state model and transmitted to the attendee device through the conversational interface.

Updated structured outputs may be written to attendee state (410) and the structured outputs are returned through conversational interface (420).

The orchestration engine continues monitoring for trigger events (430).

The system improves operational efficiency within complex event environments by dynamically balancing attendee distribution, optimizing routing throughput, and coordinating resource allocation across vendors and attractions.

The system provides an AI-driven software system that seamlessly integrates with entertainment company data, offering attendees a structured, optimized, and interactive itinerary. The system not only enhances user experience but also drives increased revenue for vendors and event organizers by enabling targeted marketing, improved crowd distribution, and streamlined navigation. The AI system ensures that attendees can easily locate food, merchandise, and attractions based on personalized preferences and real-time recommendations, reducing time wasted navigating large venues and increasing attendee satisfaction. Additionally, the system collects and analyzes consumer data to drive revenue through monetized insights, targeted advertising, and predictive analytics for entertainment companies and their partners.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed:

1. A system for assisting experience of an event, comprising:
a structured event state model;
a structured attendee state model;
a multi-agent computational architecture in communication with the structured event state model and the structured attendee state model to continuously update the structured event state model and the structured attendee state model;
an orchestration engine in communication with the multi-agent computational architecture that utilizes a constraint hierarchy governing decisions; and
a conversational interface in communication with the orchestration engine to return structured outputs for each attendee in the structured attendee state model through the conversational interface in response to real-time disruptions in the structured attendee state model and the structured attendee state model.

2. The system as recited in claim 1, wherein the structured outputs for each attendee in the structured attendee state model comprises at least one of a schedule, a computed navigation path, an optimized itinerary, a reservation written into integrated systems, a VIP/table assignments, a ride timing adjustments, a personalized offer, and structured confirmation in response to the orchestration engine.
